(19) United States
(12) Patent Application Publication
(10) Pub. No.: US 2026/0202542 A1
(43) Pub. Date: Jul. 16, 2026

(54) VERTICALLY RESOLVED OBSTACLE PROFILE USING ULTRASOUND

(71) Applicant: Valeo Schalter und Sensoren GmbH, Bietigheim-Bissingen (DE)

(72) Inventor: Henrik Starkloff, Bietigheim-Bissingen (DE)

(73) Assignee: Valeo Schalter und Sensoren GmbH, Bietigheim-Bissingen (DE)

(21) Appl. No.: 19/135,034

(22) PCT Filed: Nov. 28, 2023
(86) PCT No.: PCT/EP2023/083295

§ 371 Date: Jun. 2, 2025

(30) Foreign Application Priority Data
Dec. 1, 2022 (DE) 10 2022 131 873.7

(51) Int. Cl. G01S 15/931; G01S 7/536; G01S 15/42

(52) U.S. Cl. CPC G01S 15/931; G01S 7/536; G01S 15/42

(57) ABSTRACT

Described is a method for generating a vertically resolved obstacle profile for a vehicle using ultrasound. The method includes recording multiple echo curves received in response to a transmission of respective transmission signals generated at different ultrasonic frequencies using an ultrasonic converter that has a frequency-based transmission characteristic. A description of the transmission characteristic of the ultrasonic converter is provided for each of the ultrasonic frequencies which assigns a transmission intensity to multiple transmission angles on a vertical plane. A respective transmission angle and an obstacle distance are ascertained for signals contained in the echo curves by comparing a reception intensity difference of a signal between at least two echo curves with a transmission intensity difference between the signal characteristics. An obstacle profile is generated by combining the ascertained transmission angles with the respective corresponding obstacle distance.

The present invention relates to a method for constructing a vertically resolved obstacle profile for a vehicle by means of ultrasound, and also to a control device, an ultrasonic transducer and a vehicle.

There is a need to identify a vertically resolved profile of an obstacle situated in front of a vehicle in the direction of travel. One practical application may be parking forwards in a parking space with a ventilation duct mounted on the ceiling. For example, if the vehicle to be parked has an elongated hood, as in the case of a sedan or station wagon, the full length of the parking space can be utilized by virtue of the hood occupying the space beneath the ventilation duct. However, if the ventilation duct is incorrectly identified as an obstacle in this example, an obstacle warning that is triggered can unsettle and/or distract a driver. Another application can be distinguishing between a curb that can be driven over and a wall that cannot be driven over.

US 2020/0 201 347 A1 discloses a self-propelled device that has a housing, a movement module, a drive module and a control module. The movement module is designed to drive the housing, and the drive module is designed to drive the movement module to move. The control module is designed to control the self-propelled device. A sensor assembly for contactless obstacle identification is arranged on the housing. After the obstacle identification sensor assembly detects that there is an obstacle in a direction of movement, the control module controls the self-propelled device to continue and control movement until the obstacle is avoided, the direction of movement being the forward direction of travel of the self-propelled device. Using the example of an autonomous lawnmower, it is explained that only obstacles in a certain height range can be detected and that different field of view directions of an ultrasonic sensor can be determined by different mounting heights and angles of inclination.

Accordingly using multiple ultrasonic sensors with different mounting heights and/or angles of inclination to obtain a vertically resolved obstacle profile results in a multipartite, expensive system.

Against this background, an object of the present invention is to provide an improved approach and, in particular, to provide a reliable and inexpensive technology for constructing a vertically resolved obstacle profile.

The aforementioned object is achieved by proposing a method for constructing a vertically resolved obstacle profile for a vehicle by means of ultrasound. The method has the steps of: recording multiple echo responses received in reaction to transmission of a respective transmission signal, the transmission signals being generated at different ultrasonic frequencies by means of an ultrasonic transducer that has a frequency-dependent transmission characteristic, providing a description of the transmission characteristic of the ultrasonic transducer for each of the ultrasonic frequencies that attributes a transmission intensity to multiple transmission angles in a vertical plane, determining a transmission angle and an obstacle distance for signals included in the echo responses by comparing a reception intensity difference of a signal between at least two echo responses with a transmission intensity difference between the signal characteristics whose ultrasonic frequencies are the ultrasonic frequencies of the transmission signals, and constructing an obstacle profile by combining the determined transmission angles with the respective associated obstacle distance.

The method takes advantage of the effect that an ultrasonic transducer can have a frequency-dependent transmission characteristic. If an obstacle is not situated along a main direction of the ultrasonic transducer, but rather is diagonally offset with respect to the main direction, then a transmission intensity with which a transmission signal is emitted to the example obstacle depends on the ultrasonic frequency of the transmission signal. This difference in the transmission characteristic can lead directly to a difference in the intensity of an ultrasonic echo. If the frequency-dependent transmission characteristic is known, the angle between the main direction and the obstacle can be inferred from the difference in the intensity of the ultrasonic echo. It is therefore possible to obtain a vertically resolved obstacle profile without additional ultrasonic sensors.

The term vertical plane preferably refers to an immobile position of the vehicle in a ready-to-drive condition on a horizontal surface. A vertical plane is preferably a plane perpendicular to the current surface beneath the vehicle. If the vehicle moves on an uneven surface, the vertical plane may not be perpendicular. However, this effect is usually negligible in the context of conventional road surfaces, given the spatial resolution achieved by ultrasonic sensors. The ultrasonic sensor, the ultrasonic sensors and/or each ultrasonic sensor that is used in the method is preferably mounted on the vehicle in a manner fixed to the body.

The term vertically resolved obstacle profile preferably means a summary of a respective distance from an obstacle at multiple heights. An obstacle profile may involve no obstacle being detected at one or more heights. A vertically resolved obstacle profile is preferably constructed for a vertical plane.

Options and aspects that afford advantages over the basic form of the proposed method and thus improve the method further are outlined below. The options and aspects presented can be combined.

According to a preferred option, determining the transmission angles and obstacle distances involves performing the following steps for the multiple recorded echo responses: identifying a test signal by comparing a first echo response recorded at a first ultrasonic frequency and a second echo response of the recorded echo responses that is recorded at a second ultrasonic frequency, the test signal having a reception intensity difference between the first echo response and the second echo response, and identifying a transmission angle corresponding to the test signal in the vertical plane if the reception intensity difference corresponds to a transmission intensity difference between the transmission intensity of the first ultrasonic frequency for a transmission angle and the transmission intensity of the second ultrasonic frequency for that transmission angle. In other words: if the reception intensity difference corresponds to a transmission intensity difference between the transmission intensity of the first ultrasonic frequency for a transmission angle and the transmission intensity of the second ultrasonic frequency for that transmission angle, the transmission angle corresponding to the test signal is identified in the vertical plane.

According to one option, a first test signal included in the first echo response corresponds to a second signal included in the second echo response if a propagation time of the first signal differs from a propagation time of the second signal by no more than 10%, preferably by no more than 7% and preferentially by no more than 4%. These tolerances allow different points of reflection on the obstacle to be taken into account. As a result, the method can correctly identify, for example, large areas on the obstacle as an obstacle.

According to one option, the reception intensity difference corresponds to the transmission intensity difference if the reception intensity difference differs from the transmission intensity difference by no more than 35%, preferentially by no more than 25%, more preferentially by no more than 12.5%. In this way, the method can reliably identify, for example, obstacles with frequency-dependent reflection behavior and/or a large magnitude of wide-dispersion reflection behavior.

According to another option, the transmission signals are transmitted using an ultrasonic transducer that has a main axis, the main axis extending from the ultrasonic transducer downwards, horizontally and/or up to 20° upwards in the radiation direction. There can thus be provision for the method to be carried out using the ultrasonic transducers that have hitherto customarily been able to be installed in vehicles to identify obstacles. The directions indicated can preferably relate to a vehicle that, for example, is stationary in an unladen ready-to-drive condition on a horizontal surface.

According to another option, the same ultrasonic transducer is used to transmit the transmission signals and to receive the echo responses. This means that the method can be implemented with little outlay, for example. Additionally or alternatively, a different ultrasonic transducer is used to receive the echo responses than to transmit the echo responses. This allows, for example, an obstacle directly in front of the vehicle to be identified. In addition, for example, an obstacle that is laterally offset with respect to the ultrasonic transducer delivering the transmission signal can be reliably identified if in particular the receiving ultrasonic transducer is laterally offset in the same direction. If multiple ultrasonic transducers distributed in a horizontal direction are used for reception, an obstacle can be detected in space with multiple vertically resolved obstacle profiles. Preferably, multiple at least horizontally distributed ultrasonic transducers are used to receive respective echo responses. It is preferable if the following steps are performed for each ultrasonic transducer: recording multiple echo responses and determining a transmission angle and an obstacle distance for signals included in the echo responses.

According to another option, the method can include the following steps: determining a horizontal position of an obstacle by evaluating a propagation time difference of a test signal received by multiple at least horizontally distributed ultrasonic transducers. For example, knowledge of a relative position of the ultrasonic transducers that have received the test signal, or of the ultrasonic transducers that have transmitted the transmission signal and/or received the test signal, allows an obstacle that has reflected the test signal to be identified in space. A driver can thus be provided with even better information on where the obstacle is located.

If multiple obstacle profiles are constructed, the method can, as a development, provide for the individual obstacle profiles to be combined into a three-dimensional obstacle profile. This may be suitable particularly for overlaying and/or comparing against a scan result, for example from a laser scanner, image recognition and/or a three-dimensional map.

It may be the case that different transmission angles are attributed or can be attributed to the test signal on the basis of the different echo responses. This can be triggered, for example, by a frequency-dependent reflection behavior. This phenomenon can occur when a single ultrasonic transducer transmits and receives, when one ultrasonic transducer transmits and another ultrasonic transducer receives, when one ultrasonic transducer transmits and this and at least one other ultrasonic transducer receives, and when one ultrasonic transducer transmits and multiple other ultrasonic transducers receive. By way of example, in all of these cases, a position of the obstacle can be determined with greater accuracy by virtue of the method comprising the step of: determining a minimum, average or maximum transmission angle associated with the test signals in the vertical plane. As a development, there can be provision for a minimum to be determined for transmission angles above the main axis, for example for transmission angles above 30° above the main axis, of the transmitting ultrasonic transducer. Additionally or alternatively, as a development, there can be provision for an average to be determined for transmission angles close to the main axis of the transmitting ultrasonic transducer, for example for transmission angles in a range from 30° above the main axis to 10° below the main axis. As a development, there can be provision for a maximum to be determined for transmission angles below the main axis of the transmitting ultrasonic transducer, for example for transmission angles below 10° below the main axis. These developments are advantageous, for example, for a vehicle whose ultrasonic transducers are mounted on the most protruding body part. These developments ensure that, for safety reasons, an obstacle closest to the ultrasonic transducer is located.

It may be the case that ultrasonic transducers have a frequency-dependent reception characteristic whose magnitude is relevant to the accuracy of the method proposed here. To obtain better accuracy in this case, one option proposed is that the method has the step of: providing a description of a reception characteristic for the or each ultrasonic transducer used to receive multiple echo responses for each of the ultrasonic frequencies, each reception characteristic describing a reception intensity of a transmitted pulse for different reception angles in a vertical plane. Furthermore, it is proposed that each echo response be processed by filtering by means of the respective reception characteristic. Alternatively, the description of the reception characteristic can be combined with the description of the transmission characteristic, and the combination can be provided for the or each receiving ultrasonic transducer.

By way of example, to facilitate a signal processing of the method, and/or for example to efficiently parallelize the method, there can be provision for the ultrasonic transducer to transmit the transmission signals in order of ultrasonic frequency. It is particularly preferable for the transmission signals to be in ascending order of ultrasonic frequency, thus starting at the lowest ultrasonic frequency, which usually has the widest transmission angle. It is also particularly preferable for the method to be carried out continuously and/or repeatedly, so that a transmission signal at the highest ultrasonic frequency is followed by a transmission signal at the lowest ultrasonic frequency.

The method is particularly suitable for facilitating maneuvering in confined spaces, such as a parking garage or a parking space. By way of example, to save energy, it is therefore advantageous if the method is carried out only up to a specified maximum speed. By way of example, this maximum speed can be up to 50 km/h or more preferentially up to 30 km/h.

A computer program product is furthermore proposed, comprising instructions that, when the program is executed by a computer, cause said computer to carry out the method described above. The computer product has the features and advantages of the method that is carried out or able to be carried out.

A computer program product, e.g., a computer program means, can be provided or supplied, for example, as a storage medium, e.g. a memory card, a USB stick, a CD-ROM, a DVD, or in the form of a downloadable file from a server in a network. This can take place for example in a wireless communication network by transmitting a corresponding file containing the computer program product or the computer program means.

The object specified at the outset is achieved by proposing a control device for a vehicle. Said control device is able to be coupled to at least one ultrasonic transducer, including a group of matched ultrasonic transducers, for the purpose of information transmission. By way of example, it is able to be coupled to the at least one ultrasonic transducer via a bus. The control device is configured to carry out the method described above, preferably in the form of the computer program product described above. The control device has the features and advantages of the method that is carried out or able to be carried out.

Furthermore, the proposed control device can also be in the form of part of a superordinate control system of the vehicle, for example a central electronic control device and/or an engine control device (ECU: Engine Control Unit).

The control device can include, for example, a recording means, such as a volatile memory, and/or an interface, in particular for recording the multiple echo responses. The control device can include, for example, a storage means, such as a volatile or nonvolatile memory, in particular for providing the transmission characteristic of the ultrasonic transducer for each of the ultrasonic frequencies. The control device can include, for example, an execution means, such as a processor, in particular for determining in each case a transmission signal and an obstacle distance and for constructing the obstacle profile.

The respective means may be implemented in hardware and/or software. In the case of an implementation in hardware, the respective means can be in the form of a computer or a microprocessor, for example. In the case of an implementation in software, the respective means can be in the form of a computer program product, a function, a routine, an algorithm, part of a program code, or an executable object.

The object specified at the outset is achieved by proposing an ultrasonic transducer for a vehicle. The ultrasonic transducer is configured to carry out the method described above. To implement some of the options and/or aspects of the method described above, the ultrasonic transducer may optionally be configured to be able to be coupled to at least one ultrasonic transducer, including as part of a group of matched ultrasonic transducers, for the purpose of information transmission. The proposed ultrasonic transducer has the features and advantages of the method that is carried out or able to be carried out.

The ultrasonic transducer can include, in particular, an ultrasonic transducer means, the recording means, the storage means and/or the execution means.

Finally, the object cited at the outset is also achieved by proposing a vehicle that has at least the aforementioned control device and/or the aforementioned ultrasonic sensor. The vehicle has the features and advantages of the method that is carried out or able to be carried out, the control device and/or the ultrasonic transducer.

If both the control device and the ultrasonic sensor are present, the method steps can be performed in a manner distributed over the ultrasonic sensor and the control device. The same applies to multiple ultrasonic sensors and/or multiple control devices.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention form the subject matter of the dependent claims and of the exemplary embodiments of the invention that are described below. The invention is explained in more detail below on the basis of preferred embodiments with reference to the accompanying figures.

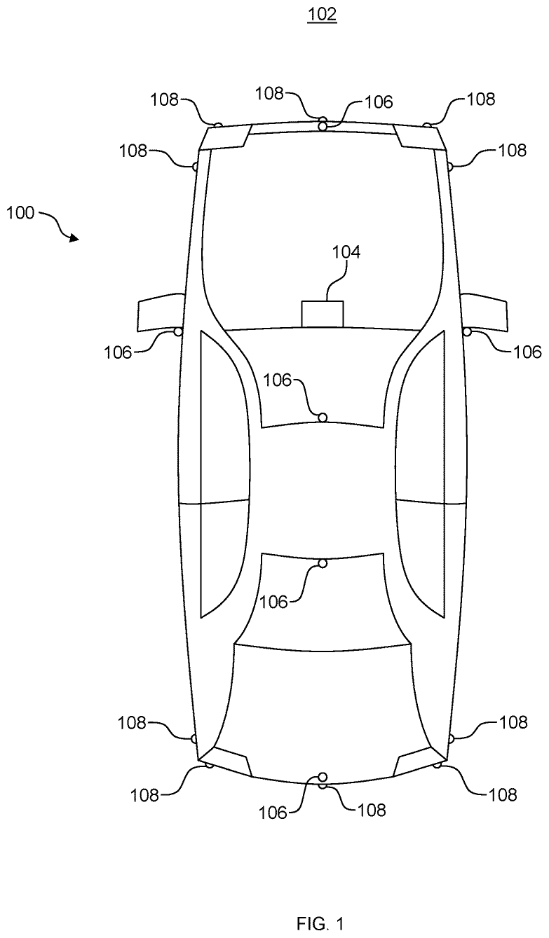

FIG. 1 shows a schematic plan view of an illustrative vehicle that has multiple ultrasonic sensors and a control device;

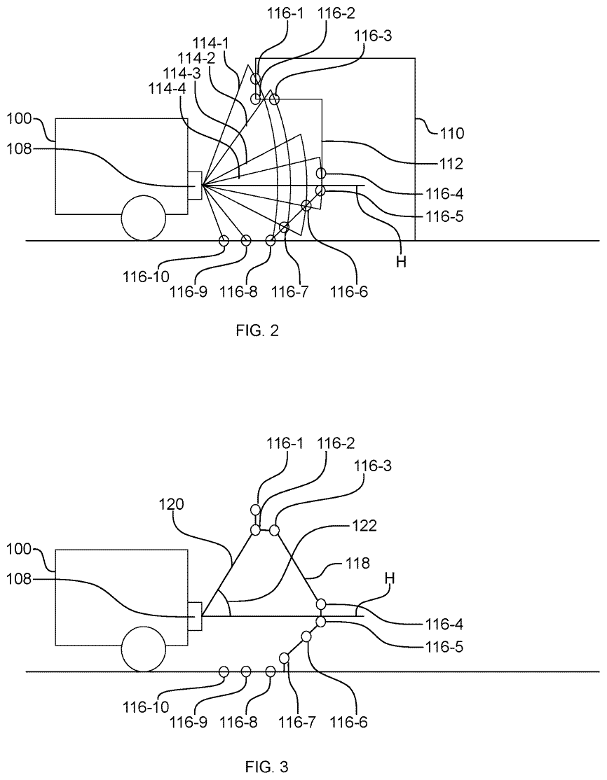

FIG. 2 shows a schematic side view of a vehicle having an ultrasonic sensor, which vehicle carries out a method according to a first embodiment of the invention;

FIG. 3 shows a schematic side view of a step of the method according to the first embodiment of the invention; and

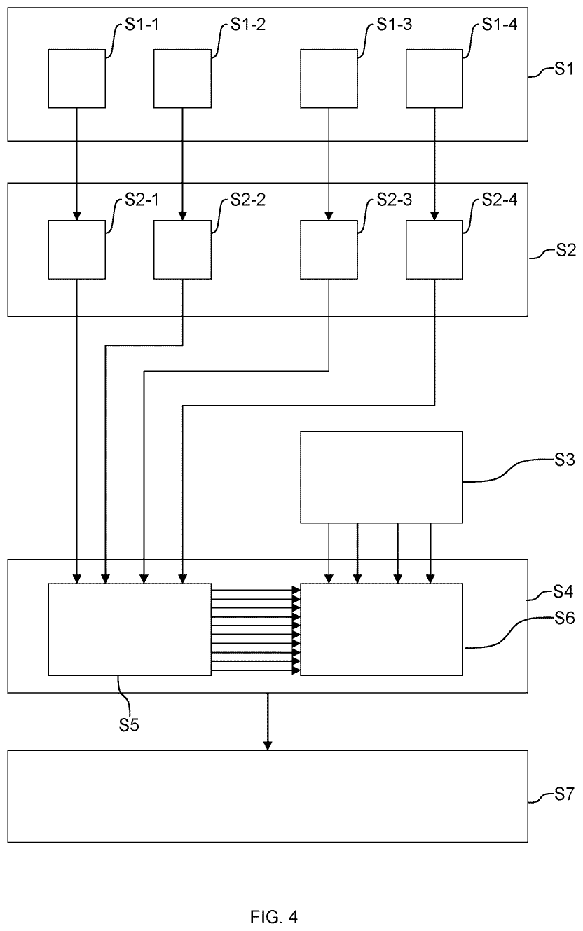

FIG. 4 shows a schematic flowchart for the method according to the first embodiment.

Identical or functionally identical elements are denoted by the same reference signs in the figures, unless stated otherwise.

FIG. 1 shows a schematic bird's eye view of a vehicle 100. The vehicle 100 is, for example, an automobile arranged in surroundings 102. The automobile 100 has a control device 104 that includes, for example, a parking assistance system.

In addition, a multiplicity of environment sensor devices 106, 108 are arranged on the automobile 100, which can be, for example, optical sensors 106 and ultrasonic sensors 108. The optical sensors 106 comprise for example visual cameras, a radar and/or a lidar. Each of the optical sensors 106 can capture an image of a respective region from the surroundings 102 of the automobile 100 and output said image as an optical sensor signal. The ultrasonic sensors 108 are designed to detect a distance from objects arranged in the surroundings 102 and to output a corresponding sensor signal. Using the sensor signals captured by the sensors 106, 108, the control device 104 is able, for example, to drive the automobile 100 partially autonomously or fully autonomously. In addition to the optical sensors 106 and ultrasonic sensors 108 shown in FIG. 1, there can be provision for the vehicle 100 to have various other sensor devices 106, 108. Examples of these are a microphone, an acceleration sensor, an antenna having a coupled receiver for receiving electromagnetically transmissible data signals, and the like.

FIG. 2 shows a side view of the vehicle 100, one of the ultrasonic sensors 108 being shown. The ultrasonic transducer 108 has a main axis H that extends horizontally. There is an obstacle 110 in the surroundings 102, which has a profile 112 that is facing the vehicle.

A method according to the invention is described below using the flowchart in FIG. 4.

The method has multiple substeps S1-1 to S1-4, which are collectively referred to as one step S1. The method also has multiple substeps S2-1 to S2-4, which are collectively referred to as one step S2.

In a first substep S1-1, the ultrasonic transducer 108 transmits a transmission signal 114-1 at an ultrasonic frequency. Subsequently, in substep S2-1, an echo response is recorded by the ultrasonic transducer 108 and the control device 104. If the transmission signal 114 strikes the obstacle 110, a reflection signal is reflected to the ultrasonic transducer 108 and recorded in the echo response. Together with the echo response, the ultrasonic frequency of the transmission signal is recorded.

Substep S2-1 is followed in a substep S1-2 by transmission of a transmission signal 114-2. In reaction to this transmission, an echo response is recorded in a substep S2-2.

Thus, transmission signals 114-1 to 144-4 are repeatedly transmitted in substeps S1-1 to S1-4, and an echo response is recorded in each of substeps S2-1 to S2-4.

In the case of the first embodiment, four different ultrasonic frequencies are used, for example. For each ultrasonic frequency, the method includes a substep S1 for transmitting and a substep S2 for recording the respective echo response.

As shown symbolically in the depiction in FIG. 2, the ultrasonic transducer 108 has a frequency-dependent transmission characteristic. For clarity, each of the four transmission signals 114-1 to 114-4 is symbolized by a circle sector. The circle sector that symbolizes the transmission signal 114-1 at the lowest ultrasonic frequency has the largest central angle. Furthermore, the circle sector that symbolizes the transmission signal 114-4 at the highest ultrasonic frequency has the smallest central angle. The circle sectors symbolize a range of high transmission intensity of the respective transmission signal 114. The representation as circle sectors is a simplification: in practice, a transmission intensity usually decreases not abruptly, but rather gradually as the angle with respect to a main direction of the ultrasonic transducer increases. The circle sectors in FIG. 2 are shown with different radii. This is another simplification: in practice, although the transmission signals 114 at different ultrasonic frequencies have different ranges, a transmission intensity usually decreases not abruptly, but rather gradually as the distance from the ultrasonic sensor 108 increases.

FIGS. 2 and 3 show ten reflections 116-1 to 116-10 by way of illustration. An echo response recorded in reaction to the transmission of the transmission signal 114-1 at the lowest ultrasonic frequency includes signals for the reflections 116-1, 116-2, 116-8, 116-9 and 116-10, for example. An echo response recorded in reaction to the transmission of the transmission signal 114-2 at the second lowest ultrasonic frequency includes signals for the reflections 116-3, 116-7, 116-8 and 116-9, for example. An echo response recorded in reaction to the transmission of the transmission signal 114-3 at the second highest ultrasonic frequency includes signals for the reflections 116-6 and 116-7, for example. An echo response recorded in reaction to the transmission of the transmission signal 114-4 at the highest ultrasonic frequency includes signals for the reflections 116-4, 116-5 and 116-6, for example.

In a next step S3, a description of the signal characteristic of the ultrasonic transducer 108 is provided for each of the, for example, four ultrasonic frequencies. By way of example, four signal characteristic descriptions are thus provided. It should be noted that the signal characteristic descriptions can be provided as a combined file, a combined table, or a software function or method. Each description of a signal characteristic attributes a respective transmission intensity to multiple transmission angles in a vertical plane. In other words: a description of a transmission characteristic indicates, for example, a transmission intensity distribution of the ultrasonic transducer 108 for the respective ultrasonic frequency relative to a transmission angle.

In a next step S4, a transmission angle 118 and an obstacle distance 120 are determined for signals included in the echo responses on the basis of the description of the transmission characteristics. For this purpose, the method uses at least one comparison of at least one reception intensity difference of at least one signal between at least two echo responses with at least one transmission intensity difference between the signal characteristics whose ultrasonic frequencies are the ultrasonic frequencies of the transmission signals in reaction to which precisely these at least two echo responses have been recorded.

By way of example, steps S5 and S6 are provided for this purpose.

In step S5, test signals are first of all identified. This is accomplished by comparing a first echo response of the set of recorded echo responses and a second echo response of the set of recorded echo responses with one another. The first echo response is recorded in reaction to transmission of a transmission signal 114 at a first ultrasonic frequency, and the second echo response is recorded in reaction to transmission of a transmission signal 114 at a second ultrasonic frequency, the second ultrasonic frequency being different than the first ultrasonic frequency. If the method finds a signal in the two echo responses that has a reception intensity difference between the two echo responses, this signal is a test signal, which is examined in greater detail hereinafter.

The reception intensity is, for example, a signal strength of a received signal. By way of example, an echo response is first of all post-processed, for example filtered and/or smoothed, using known methods. By way of example, artefacts such as ground echoes are filtered out by means of an algorithm. The reception intensity corresponds, for example, to an amplitude of a peak in the echo response.

A reception intensity difference can be expressed in absolute terms, for example in dB or for example in volts. A reception intensity difference can be expressed, for example, in relative terms in percent based on, for example, the amplitude of the signal of the echo response at the lower ultrasonic frequency. The transmission characteristics are preferably such that a transmission intensity difference is of the same nature (dB, volts, percent) as the reception intensity differences that are to be compared therewith.

In step S6, the respective reception intensity difference is compared with transmission intensity differences. A reception intensity difference exists in particular between two echo responses that are each received in reaction to a transmission signal at a particular ultrasonic frequency. To remain in the above example, these are the first and second ultrasonic frequencies. The transmission characteristics of the first and second ultrasonic frequencies are then compared. By way of example, a check is performed for each angle in the transmission characteristics to ascertain whether a transmission intensity difference for this angle corresponds to the reception intensity difference found in step S5.

The ultrasonic frequencies are preferably in a range of 52 KHz±20 kHz, more preferably in a range of 52 KHz±12 kHz, more preferably in a range of 52 KHz±6 kHz and most preferably in a range of 52 KHz±3 kHz.

If, in the check in step S6, the reception intensity difference found in step S5 corresponds to a transmission intensity difference between the transmission intensity of the first ultrasonic frequency for a transmission angle and the transmission intensity of the second ultrasonic frequency for that transmission angle, this transmission angle is identified in the vertical plane as the transmission angle corresponding to the test signal.

Step S5 is performed for each signal included in the echo responses. Step S6 is performed for each test signal found in step S5. In the example of FIGS. 2 to 4, the signals of all 10 reflections 116-1 to 116-10 are treated as test signals.

Thus, the result of steps S5 and S6 is that in superordinate step S4 there is a set of values that includes an obstacle distance and a transmission angle, or multiple such sets of values or no set of values. If an obstacle distance cannot be attributed to a transmission angle, the method is terminated.

In a next step S7, an obstacle profile 118 is constructed. This obstacle profile 118 is shown in FIG. 3, for example. As shown by means of the test signal for the reflection 116-2, a position of the reflection is calculated from the obstacle distance 120 determined in step S5 and the transmission angle 122 determined in step S6. As a result, 10 positions of the reflections 116-1 to 116-10 are calculated.

A preferred optional post-processing step identifies test signals at road level so that said test signals are not included in construction of the obstacle profile 118. The reflections 116-8 to 116-10 can therefore be ignored when constructing the obstacle profile 118.

Constructing the obstacle profile 118 involves, for example, drawing a continuous line through the positions that are obtained by combining the identified transmission angles (122) with the respective associated obstacle distance (120).

Comparison of FIGS. 2 and 3 reveals that the actual obstacle profile 112 in FIG. 2 and the constructed, or identified, obstacle profile 118 in FIG. 3 differ slightly from one another. This difference is usually tolerable, since the method S1 to S7 is preferably carried out repeatedly when the obstacle is approached, and since the method S1 to S7 is usually used for roughly orienting the driver.

In the present example, the vehicle 100 or at least the part of the vehicle 100 shown in FIG. 3 fits under the point on the obstacle 110 that produces the reflection 116-2. An obstacle warning device can therefore alert the driver to the proximity to the reflection 116-2, for example, without warning of a collision with the point pertaining to the reflection 116-2. As a result, the driver can maneuver the vehicle 100 closer to the obstacle 110.

According to a second embodiment, which is not shown in the figures, multiple ultrasonic transducers 108 are used for the method. By way of example, an ultrasonic transducer 108 is used for transmitting the transmission signals 114, and multiple other horizontally distributed ultrasonic transducers 108 are used for receiving and recording the echo responses. The receiving ultrasonic transducers 108 are thus arranged around a vertical axis of the vehicle 100 at different angles.

By way of example, steps S2 and S4 to S7 are performed separately for each of the multiple receiving ultrasonic transducers 108. There is therefore provision for each of the multiple receiving ultrasonic transducers 108 to record multiple echo responses in step S3, to determine multiple transmission angles and obstacle distances in multiple passes of steps S4 to S6, and then to determine a respective obstacle profile 118 in step S7.

This means that multiple obstacle profiles 118 are determined, each of which is associated with a vertical plane. By way of example, the control device 104 can therefore better alert the driver of the vehicle 100 to obstacles in the surroundings 102 when the vertical planes are known.

In a variant, step S7 is performed not for each individual receiving ultrasonic transducer 108, but rather for all sets of values of all ultrasonic transducers 103 collectively, in order to arrive at a three-dimensional obstacle profile 118 directly.

In a variant of this embodiment, a combined obstacle profile is constructed from the multiple obstacle profiles 118 in a next step. It will thus be a three-dimensional obstacle profile. This three-dimensional obstacle profile can be used, for example, for comparison against a stored three-dimensional model of a parking garage and/or for comparison against an image or model of the surroundings 102 that is obtained by the optical sensors 106.

Although the present invention has been described on the basis of exemplary embodiments, it is modifiable in a variety of ways.

### LIST OF REFERENCE SIGNS

100 vehicle
102 surroundings
104 control device
106 optical sensor
108 ultrasonic sensor
110 obstacle
112 profile
114 transmission signal
116 reflection
118 obstacle profile
120 obstacle distance
122 transmission angle
H main axis

1. A method for constructing a vertically resolved obstacle profile for a vehicle by means of ultrasound, comprising:
recording multiple echo responses received in reaction to transmission of a respective transmission signal, the transmission signals being generated at different ultrasonic frequencies by means of an ultrasonic transducer that has a frequency-dependent transmission characteristic;
providing a description of the transmission characteristic of the ultrasonic transducer for each of the ultrasonic frequencies that attributes a transmission intensity to multiple transmission angles in a vertical plane;
determining a transmission angle and an obstacle distance for signals included in the echo responses by comparing a reception intensity difference of a signal between at least two echo responses with a transmission intensity difference between the signal characteristics whose ultrasonic frequencies are the ultrasonic frequencies of the transmission signals; and
constructing an obstacle profile by combining the determined transmission angles with the respective associated obstacle distance.

2. The method as claimed in claim 1, wherein determining the transmission angles and obstacle distances comprises: performing the following steps for the multiple recorded echo responses:
identifying a test signal by comparing a first echo response recorded at a first ultrasonic frequency and a second echo response of the recorded echo responses that is recorded at a second ultrasonic frequency, the test signal having a reception intensity difference between the first echo response and the second echo response; and
identifying a transmission angle corresponding to the test signal in the vertical plane if the reception intensity difference corresponds to a transmission intensity difference between the transmission intensity of the first ultrasonic frequency for a transmission angle and the transmission intensity of the second ultrasonic frequency for that transmission angle.

3. The method as claimed in claim 1, wherein the transmission signals are transmitted using an ultrasonic transducer that has a main axis, the main axis extending from the ultrasonic transducer downwards, horizontally and/or up to 20° upwards in a radiation direction.

4. The method as claimed in claim 1, wherein the ultrasonic transducer transmits the transmission signals in order of ultrasonic frequency, the transmission signals being in ascending order of ultrasonic frequency and a transmission signal at a highest ultrasonic frequency being followed by a transmission signal at a lowest ultrasonic frequency.

5. The method as claimed in claim 1, wherein the same ultrasonic transducer is used to transmit the transmission signals and to receive the echo responses.

6. The method as claimed in claim 1, wherein a different ultrasonic transducer is used to receive the echo responses than to transmit the transmission signals.

7. The method as claimed in claim 1, wherein multiple at least horizontally distributed ultrasonic transducers are used to receive respective echo responses, the following steps being performed for each ultrasonic transducer:
recording multiple echo responses; and
determining a transmission angle and an obstacle distance for signals included in the echo responses.

8. The method as claimed in claim 1, comprising: determining a horizontal position of an obstacle or obstacle part reflecting a signal by evaluating a propagation time difference of a test signal received by multiple at least horizontally distributed ultrasonic transducers.

9. The method as claimed in claim 8, further comprising determining a minimum, average or maximum transmission angle associated with the test signals in the vertical plane.

10. A method for constructing a three-dimensional obstacle profile as claimed in claim 5, comprising: combining individual obstacle profiles into a three-dimensional obstacle profile.

11. The method as claimed in claim 1, comprising: providing a reception characteristic for each ultrasonic transducer used to receive multiple echo responses for each of the ultrasonic frequencies, each reception characteristic describing a reception intensity of a transmitted pulse for different reception angles in a vertical plane.

12. A computer program product comprising instructions that, when the instructions are executed by a computer, cause the computer to carry out the method as claimed in claim 1.

13. A control device for a vehicle, which is coupled to at least one ultrasonic transducer for the purpose of information transmission, and which is configured to carry out the method as claimed in claim 1.

14. An ultrasonic transducer for a vehicle, which is coupled to at least one further ultrasonic transducer for the purpose of information transmission and configured to carry out the method as claimed in claim 6.

15. A vehicle having a control device as claimed in claim 13.
